(19) United States
(12) Patent Application Publication
(10) Pub. No.: US 2003/0226450 A1
(43) Pub. Date: Dec. 11, 2003

(54) Temperature stabilized coffee urn

(76) Inventors: Robert Haber, Woodcliff Lake, NJ (US); David Haber, Armonk, NY (US)

Correspondence Address: Charles E. Temko, 22 Marion Road, Westport, CT, 06880, US

(21) Appl. No.: 10/435,246

(22) Filed: May 12, 2003

Related U.S. Application Data
(60) Provisional application No. 60/387,723, filed on Jun. 11, 2002.

(51) Int. Cl. A23F 3/00

(52) U.S. Cl. 99/279

(57) ABSTRACT

An insulated coffee urn having an outer shell element and an inner shell element forming a thermally-insulative chamber with said outer shell element, and an elongated electrical heating element positioned within said chamber. The heating element is variably electrically conductive depending upon the temperature within said chamber. The heating element is employed to preheat the interior of the urn to predetermined temperature prior to use, and is disconnected prior to filling the urn with brewed coffee.

### RELATED APPLICATION

Reference is made to our copending provisional application, Serial No.: 60/387,723, filed Jun. 11, 2002 under the title Insulated Coffee Urn, to which a claim of priority is made.

### BACKGROUND OF THE INVENTION

This invention relates generally to the field of coffee urns and similar receptors, and more particularly to those adapted for institutional use in dispensing large numbers of individual portions of coffee or other beverage over a given interval. It is known in the art to provide such devices with heating means to maintain the coffee at a drinkable temperature which constructions have met with limited success depending upon the size of the device, and how quickly the device is placed in service following cleaning and washing procedures. Because of the nature of brewed coffee, the urn must normally be washed with every new use to avoid flavor contamination.

In recent years a problem has appeared in that it has been found that adding heat to an urn to maintain temperature of the contained brewed coffee has been deleterious to coffee flavor, particularly in the case of specialized coffees. This problem requires that to maintain brewed coffee temperature over a reasonable period, usually about two hours for a three to five gallon urn, the interior of the urn must be preheated to approximately 190 degrees F. in order not to prematurely cool the coffee. In the past, this has been done by filling the urn with heated water just prior to use, and subsequently discarding the water, which has been obtained from a coffee brewer. However, at the same time, this hot water is needed for use in brewing coffee.

There thus arises a need to independently preheat the coffee urn so as to be ready for use prior to being charger with fresh coffee.

### SUMMARY OF THE INVENTION

Briefly stated, the invention contemplates the provision of an improved coffee urn of the type described in which means have been incorporated for preheating the urn to operating temperature and substantially maintaining such operating temperature after recharging with fresh coffee and periodically dispensing individual portions. To this end, the urn incorporates a vacuum chamber positioned within an outer shell element, and a thermostatically sensitive resistance heating element, the electrical conduction of which varies with perceived ambient temperature, so that uniformity of internal temperature is maintained prior to use. This heating element is preferably supported on an outer surface of an inner shell element of the urn.

### BRIEF DESCRIPTION OF THE DRAWING

In the drawing, to which reference will be made in the specification:

FIG. 1 is a vertical sectional view of an embodiment of the invention.

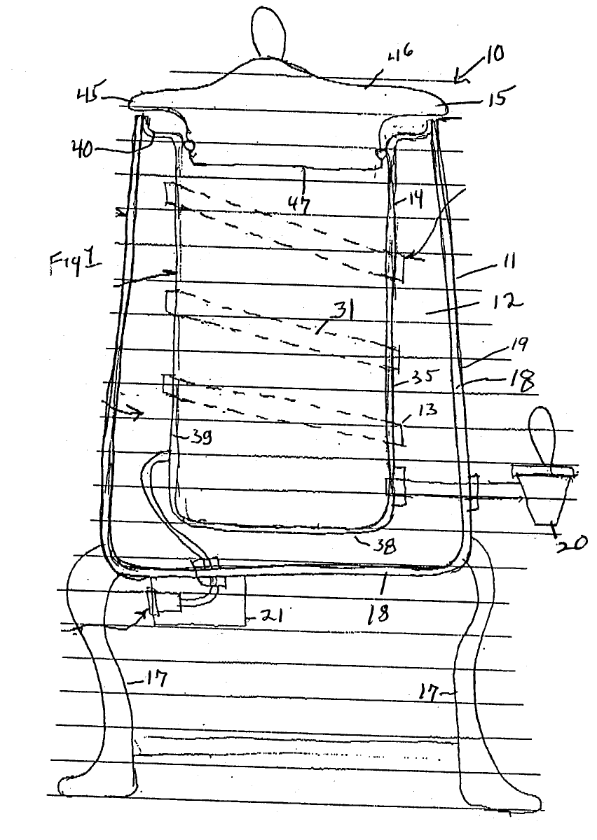

### DETAILED DESCRIPTION OF THE DISCLOSED EMBODIMENT

In accordance with the invention, the device, generally indicated by reference character 10, broadly comprises an outer shell element 11 forming an insulative chamber 12, a heating element 13, an inner shell element 14, and a lid or cover element 15.

The outer shell element 11 is of generally conventional construction, including a lower wall member 16 having supporting legs 17 for resting the device on a horizontal surface, a cylindrical side wall 18, an outer surface 19 of which supports a faucet 20. An upper edge 22 and lower edge 23 are of circular configuration. An electrical jack connection 21 is supported on the lower wall member 16.

The insulative chamber 12 is positioned between the inner surface of the outer shell element 11, and the inner shield element 14 which includes a transversely-extending tube 24 for liquid flow, and electrical jack connection 25 passing through the outer shell element 11 adjacent a bottom wall 27.

The heating element 13 may be essentially similar to devices which are employed for melting ice during winter time upon the roof of a dwelling, and is in the form of an electrically resistive-conductive cable 31 having a pair of parallel conductors imbedded in the resistive material which conducts in accordance with sensed ambient temperature. Cable of this device is commercially available under the trademark DEKORON, manufactured by Unitherm Heat Trace Co., of Cape Coral, Fla. For simplicity in manufacture, it is preferably would in a coil on the outer surface 35 of the inner shell element 14.

The inner shell element 14 may be formed in suitable manner, and includes the bottom wall 27, the cylindrical side wall 28, and an upper threaded rim 40 which extends to engage the inner surface of the outer shell element and provide a supporting surface for the lid 15.

The lid 15 may be of conventional configuration, and is bounded by peripheral rim 45, an outer surface 46 and an inner surface 47.

Operation of the device will be apparent from a consideration of the drawing. Prior to being placed in service, the device is connected to a power source (not shown) through the electrical jack connection 21, following which the interior void of the device will be heated as the inner shell element is warmed by the heating element. Since the lid is in place, this function may be performed over a period of time and maintained at predetermined temperature, so that by the time preparation of the coffee has been completed, it may be poured directly into the element 14 where it will remain for dispensing of individual cups through the faucet 20.

When the device is positioned at a serving location, it is disconnected from the power source whereby it maintains the temperature of the subsequently charged coffee solely as a result of its insulative function.

We wish it to be understood that we do not consider the invention to be limited to the precise details of structure set forth in the disclosure, for obvious modifications will occur to those skilled in the art to which the invention pertains.

We claim:

1. A dispensing urn for coffee and other beverages comprising: an outer shell element and an inner shell element positioned within said outer shell element to form an insulative chamber therebetween; an elongated heating element having an electrically-resistive body, the conductivity of which varies with ambient temperature, supported within said insulative chamber; said inner shell element forming a void for the reception of a brewed beverage.

2. A dispensing urn in accordance with claim 1, said outer shell element having electrical plug means mounted on an outer surface thereof communicating with said heating element.

3. A dispensing urn in accordance with claim 1, said heating element being supported on an outer surface of said inner shell element.

4. The method of dispensing brewed coffee from an urn over a predetermined temperature range comprising the steps of:
a) providing an insulative urn having thermostatically controlled electrically-powered internal heating means;
b) preheating the interior of said urn to predetermined temperature, using said internal heating means;
c) disconnecting said heating means, and
d) filling said urn with freshly brewed coffee for serial dispensing; whereby the temperature of said coffee is maintained solely by the insulative function of said urn.
